(19) United States
(12) Patent Application Publication
(10) Pub. No.: US 2008/0024618 A1
(43) Pub. Date: Jan. 31, 2008

(54) Adaptive binning method and apparatus

(76) Inventors: Suk Hwan Lim, Mountain View, CA (US); D. Amnon Silverstein, Mountain View, CA (US); Qian Lin, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/496,845

(22) Filed: Jul. 31, 2006

(51) Int. Cl. H04N 5/228

(52) U.S. Cl. 348/222.1

(57) ABSTRACT

An image processing method and device are described. The method includes the steps of capturing the contents a scene in a first pass, determining a binning pattern for pixels representing the scene based on measured brightness values of the pixels and capturing contents of the image in a second pass using the binning pattern.

### BACKGROUND

The quality of an image is partially dependent on the size of pixels forming the image. While reducing the size of pixels leads to an increase in the spatial resolution of an image, shrinking the pixels beyond a particular size leads to a degradation in the image quality. The decrease in image quality in this case is due to a decrease in signal-to-noise ratio (SNR) of the individual pixels.

The SNR of individual pixels is determined by the number of photons captured. There exists a direct relationship between the number of photons captured in a pixel and the SNR of the pixel. That is, an increase in the number of captured photons leads to an increased SNR; conversely, a decrease in the number of captured photons leads to a decreased SNR. It is desirable to have a high SNR. Since smaller pixels capture a smaller number of photons, reduction or shrinking of the pixels leads to a lower SNR at each pixel location.

This problem (i.e. a decrease in the number of photons captured) is compounded by pixel vignetting effect (or, narrow pixel tunneling effect) that lowers the optical quantum efficiency and results in even smaller number of photons being captured at off-center pixels. An exposure time can be increased to obtain better quality in the optical elements but the increase in quality is limited by motion blur and limited well capacity.

At least some embodiments provide methods for dynamically optimizing pixel quality in terms of signal-to-noise ratio and spatial resolution.

### SUMMARY

In one aspect, an image processing method is described. The method includes the steps of capturing contents of a scene in a first pass; determining a binning pattern for pixels representing the scene based on measured brightness values of the pixels; and capturing contents of the scene in a second pass in accordance with the binning pattern.

In another aspect, an image processing method is described. The method includes the steps of capturing contents of a scene in a first pass at a first resolution; measuring brightness values of pixels representing said scene; evaluating a spatial gradient of the pixels; determining a binning pattern for the pixels based on the spatial gradient; and capturing contents of the scene in a second pass at a second resolution in accordance with the binning pattern wherein the second resolution is higher than the first resolution

In a further aspect, a computer-readable medium containing a computer program for processing an image is described. The computer program, when executed on a processor, causes the processor to: instruct an image sensor to capture contents of a scene in a first pass; determine a binning pattern for pixels representing the scene based on measuring brightness of pixels representing the scene; and instruct the image sensor to capture contents of the scene in a second pass in accordance with the binning pattern.

In yet another aspect, a device is described. The device comprises an image capturing means, a processing means and a storage means. The processing means instructs the image capturing means to capture contents of the scene in a first pass, evaluates pixels representing the scene to determine a binning pattern and instructs the image capturing means to capture contents of the scene in a second pass according to the binning pattern.

### BRIEF DESCRIPTION OF THE DRAWINGS

The accompanying drawings, which are incorporated in and constitute a part of the specification, illustrate an embodiment of the invention and, together with the description, explain the invention. In the drawings,

FIG. 1 illustrates a black and white image sensor;

FIGS. 2A-2C illustrate image sensors with overlaying Bayer mosaic pattern for each of red, green and blue pixels respectively;

FIG. 3 illustrates a method in accordance with an exemplary embodiment;

FIG. 4A illustrates a 9 pixel by 9 pixel sensor;

FIG. 4B illustrates a pixel space for image captured in a lower resolution;

FIGS. 5A-5C illustrate lookup tables according to exemplary embodiments; and

FIG. 6 illustrates a device in accordance with exemplary embodiments.

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

In general, the present invention is a method and apparatus for dynamically optimizing the extent of binning. Specifically, pixels within images may be evaluated to determine a level of binning that may be applied to the pixels in order to increase the quality of an image.

For purposes of this invention, an image may represent contents of a scene that has been captured by an image sensor of an image capturing device. The image capturing device may be a digital camera for example.

Pixels may be binned within an area of an image sensor. Each pixel consists of photo elements that capture photons and convert them to charges (or, electrons). Neighboring pixels may have captured a different number of charges based on the scene content and noise in each pixel for example. By binning a plurality of pixels, the number of charges corresponding to each pixel within the binned pixel group may be summed. By summing charges, the signal-noise-ratio (SNR) may be increased. An increased SNR is desirable as a lower SNR indicates an image that is not as clean as an image with higher SNR (and lower noise). A clean image appears smooth in that it may not include or exhibit false speckles, dots, blotches, etc. Resolution is also important as a low resolution image fails to provide adequate image detail. A higher resolution image provides greater detail than an image with a lower resolution.

Four pixels may be binned together in a portion of the image sensor represented by a 2×2 (or 4×1 or 1×4) pixel space. Other binning examples may include sixteen pixels being binned as represented by a 4×4 pixel space (or 2×8, 8×2, 16×1 or 1×16), etc.

If an image sensor has a 4 mega pixel resolution capability for example (represented as a 2K×2K sensor), a 2×2 binning would result in the image captured on the 4 mega pixel sensor being a 1K×1K image or an image having 1 Mega-pixel resolution. That is, four pixels would be treated as one pixel thus resulting in the reduced image resolution. By binning pixels, the SNR may be increased. Binning, however, also reduces horizontal and/or vertical spatial resolution.

Another factor to consider in binning pixels is the brightness differences between pixels that are to be binned together. It is desirable to bin similar pixels. Similar pixels refers to photometric similarity or similarity in brightness. In order to bin pixels, the difference in brightness values between the pixels being binned has to be below a pre-specified threshold. That is, if the brightness difference between two pixels is higher than the threshold, then the two pixels should not be binned together. Binning pixels with a high brightness value difference may result in lost detail and blur within an image containing these pixels. The acceptable limits for brightness value differences may therefore be pre-computed in a lookup table for example. The threshold values in the look-up-table can be pre-computed from the image sensor specifications and the capture parameters.

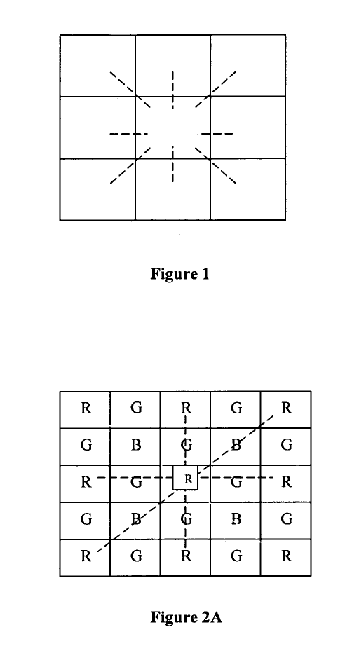

For the image sensors with an overlaying Bayer pattern mosaic, binning may only be performed between pixels capturing the same color. A pixel that captures the brightness of red color may not be binned with a pixel that captures the brightness of blue color or green color for example. Binning may be performed on neighboring pixels, such as a 3×3 pixel space for example, using black and white image sensors as illustrated in FIG. 1. This type of binning (i.e. on a 3×3 pixel space) may not be effective on image sensors having an overlaying Bayer pattern mosaic which is utilized by the majority of digital cameras.

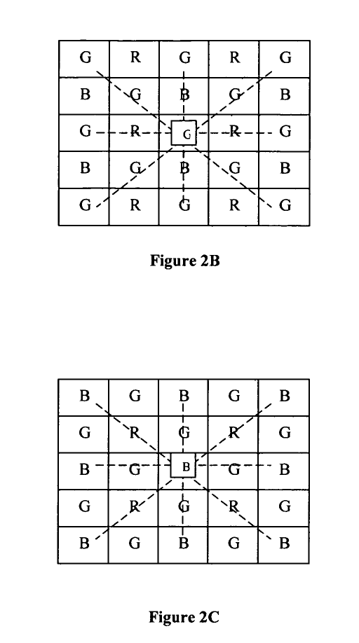

Binning may be increased to a 5×5 pixel space with a Bayer pattern mosaic as illustrated in FIGS. 2A-2C. The illustration in each of these figures corresponds to individual colors of red (R), green (G) and blue (B) respectively. For the green pixels identified in FIG. 2A, a 3 by 3 binning is also available. Dotted lines represent instances where binning is allowed.

Optionally, the concept of optimal pixel size may be introduced to simplify the process of determining the binning pattern. A discussion on how to statically design an image sensor for optimal pixel sizes is described in a paper entitled How Small Should Pixel Size Be? by T. Chen et al. (“Chin”). The subject matter of this paper is incorporated herein by reference.

The optimal pixel size may be used as a guidance to determine the extent of binning to be applied. In exemplary embodiments, brightness values of pixels making up an image may be used to determine a binning pattern.

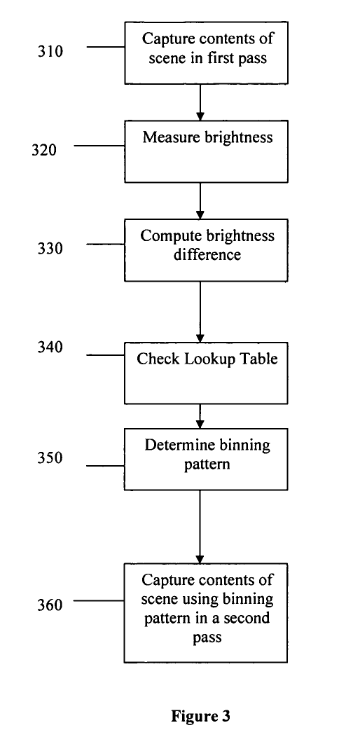

Exemplary methods may be illustrated with reference to the flow chart of FIG. 3. The initial capture of an image in a first pass may take place at step 310. Brightness values for each pixel of the captured image may be read out or measured at step 320. Brightness values between neighboring pixels may be compared at 330 to determine if the neighboring pixels satisfy the conditions for binning. That is, a difference in brightness values between the neighboring pixels may be computed. The decision on binning may be made by utilizing a lookup table at 340 that includes acceptable brightness difference value (i.e. a threshold) for a particular brightness value.

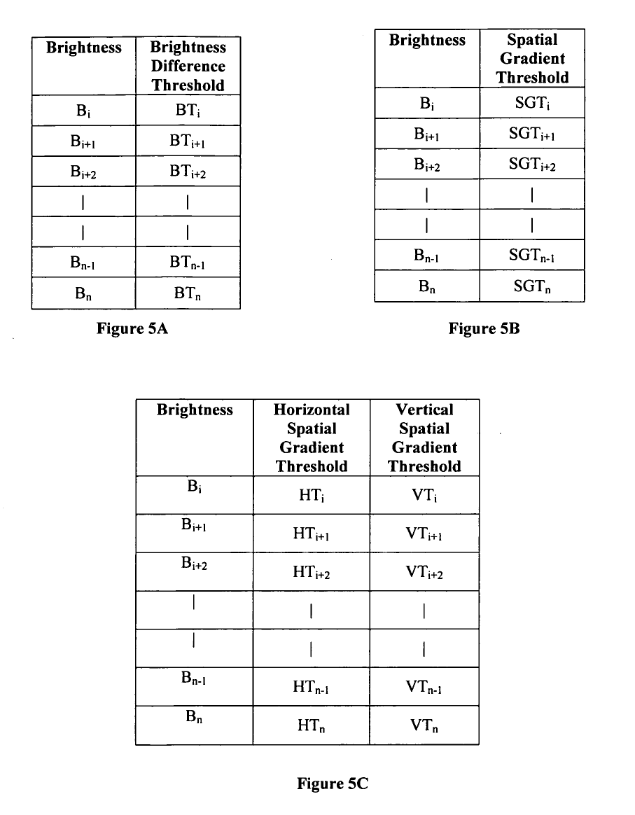

The entries in the lookup table, illustrated in FIG. 5A, include brightness values and corresponding threshold values (columns 1 and 2 of FIG. 5A). If the (computed) brightness difference between neighboring pixels is greater than the threshold for a particular corresponding brightness value, binning may not take place. If the difference is less than the threshold, binning may take place. If the difference is equal to the threshold, binning may take place.

In some embodiments, an average brightness value for (two) neighboring pixels may be computed and this average value may be used as the brightness values in the lookup table.

A binning pattern may be determined for each pixel at step 350 based on the comparison with the threshold values at step 340. The image may be captured in a second pass at step 360 utilizing the binning pattern determined at step 350.

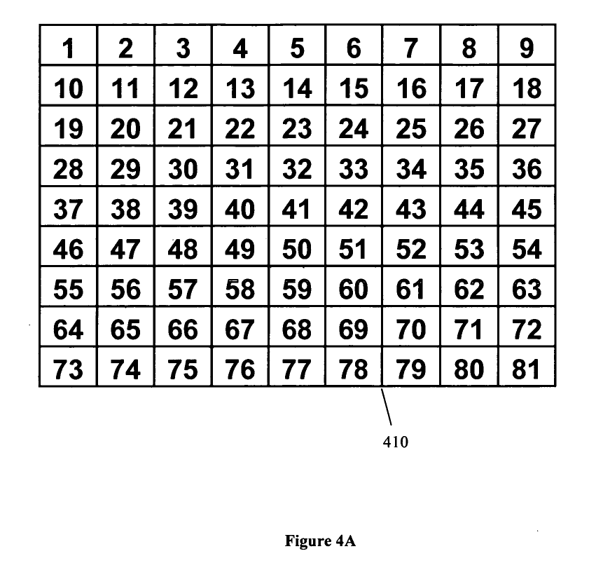

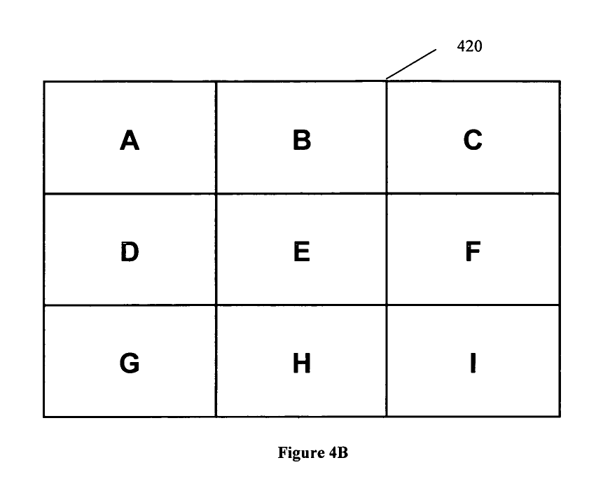

An exemplary method may be described with reference to a sensor, such as sensor 410, illustrated in FIG. 4A. In a first pass (step 310 of FIG. 3), a full resolution (i.e. 9×9 in this example) scan results in capturing information for each of the eighty one pixels (1-81) that make up an image on sensor 410.

Brightness values for each pixel may be measured from the captured information (step 320). Pixels 41 and 42 (for purely illustrative purposes) may be analyzed to determine if they can be binned together. The brightness difference between pixels 41 and 42 may be computed (step 330).

The brightness value of either pixel 41 or 42 (or the average brightness value of pixels 41 and 42) may be used to find a matching brightness value in column 1 of FIG. 5A (step 340) such as brightness value Bᵢ₊₂ for example. The brightness difference value may then be compared to the corresponding threshold value in column 2 (i.e. Tᵢ₊₂) to determine whether pixels 41 and 42 can be binned. As described above, binning may take place if the brightness difference is below the threshold value (binning cannot take place if the difference is greater than the threshold).

In alternative embodiments, an image (such as the exemplary illustrative image on sensor 410 of FIG. 4A with 81 pixels) may be captured during the first pass in low resolution where the pixels are binned in a static pattern throughout the image. An exemplary static pattern for the image on sensor 410 of FIG. 4A may be a 3×3 pattern resulting in an image made up of sensor 420 of FIG. 4B.

Low resolution in this context may indicate a resolution that is lower than the maximum resolution of the image sensor. Since the pixels are binned, the signal-to-noise-ratio is increased and it is possible to obtain acceptable signal-to-noise ratio even with a short exposure time. In this manner, the capture time for the first pass which includes time for exposure, readout and processing may be shortened (or, minimized) and the bin pattern obtained in the first capture would provide optimum results for the second pass.

Referring to FIG. 4A, an exemplary first pass low resolution capture may bin pixels 1-3, 10-12 and 19-21 into one “super” or “combined” pixel when the first pass low resolution capture is performed by binning 3×3 pixels throughout the image. Other “super” or “combined” pixels in this example may be composed of pixels 4-6, 13-15 and 22-24; 7-9, 16-18 and 25-27; etc. when the first pass low resolution capture is performed by binning 3×3 pixels throughout the image. The “super” pixels of FIG. 4A may be designated as A to I (i.e. the nine super pixels of FIG. 4B) for example.

Brightness values for each of “super” pixels A to I may be measured after capturing contents of the scene in the first low resolution pass. The brightness value of each “super” pixel corresponds to an average brightness value for each of the pixels making up the “super” pixel (i.e. the average brightness value of pixels 1-3, 10-12 and 19-21 is the brightness value of “super” pixel A in FIG. 4B).

A binning pattern may be determined before the second pass in this exemplary embodiment by computing the spatial gradient of the brightness value of each binned “super” pixel.

Spatial gradient is a known concept and with reference to each pixel, it is a derivative of the brightness with respect to both horizontal and vertical space. A magnitude of the spatial gradient may be computed using any of a number of known methods. A sum of the absolute values of each component (horizontal, vertical) or a sum of the square values of each component or average of the differences between neighboring pixels may be determined.

The brightness value and the spatial gradient for each super pixel (such as A to I) may be used to determine whether to bin the pixels. A lookup table in this embodiment (FIG. 5B) includes brightness values and corresponding threshold values with which to compare the spatial gradient.

Binning pixels with a high spatial gradient may result in lost detail and blur within an image that includes such binned pixels. Binning may also be performed separately for the vertical direction and for the horizontal direction. In this scenario (i.e. FIG. 4B), separate threshold values for the horizontal and vertical component of the gradient may be specified in the lookup table—one for the horizontal component and one for the vertical component as illustrated in FIG. 5C.

The term INTER as used herein refers to binning pixel(s) from one “super” pixel with pixel(s) from another (neighboring) “super” pixel. The term INTRA refers to binning between pixels forming a “super” pixel.

In situations where the gradient for a binned “super” pixel is high, it may not be advisable to bin between the pixels that make up the “super” pixel (INTRA). That is, for example, if the spatial gradient of “super” pixel E in FIG. 4B is high, then pixels 31-33, 40-42 and 49-51 in FIG. 4A may not be binned. It may also not be permissible to bin the pixels in a “super” pixel (having an unacceptable or high spatial gradient threshold) with pixels from a neighboring “super” pixel (INTER) (such as binning the pixels 33 and 34, 42 and 43, 51 and 52, etc.).

Conversely, if the spatial gradient of a “super” pixel is acceptable for INTRA binning, then the pixels forming the “super” pixel may be binned. Similarly, if the spatial gradient of a “super” pixel is acceptable for INTER binning, then the pixels in the “super” pixel may be binned with neighboring pixels outside the “super” pixel.

If the vertical component of the spatial gradient is high, then it may be advisable to disallow binning in the vertical direction. If the horizontal component of the spatial gradient is high, then it may be advisable to disallow binning in the horizontal direction.

In other embodiments, separate threshold values may be specified for INTER pixel binning and INTRA pixel binning in the lookup table. As INTER pixel binning has a higher probability of creating blurry pixels, it may be advisable to have lower threshold for INTER pixel binning.

The decision made in the “super” pixel (to bin or not to bin) applies equally to all pixels forming the “super” pixel (for both horizontal and vertical components). If, for example, a decision was made to bin horizontally, then all the pixels that make up the “super” pixel will inherit that decision. This is also applicable for inter pixel binning (For example, pixels 33, 42 and 51 share the same decision). The difference between inter and intra pixel binning is that the decision for inter and intra may not be the same due to potentially different threshold values for inter pixel binning and intra pixel binning mode as described above.

From a hardware implementation perspective, binning implies electrically connecting the multiple photo elements in multiple pixels (of an image sensor) being binned while disconnecting the rest. That is, if pixels 31-33 (FIG. 4A) are binned (horizontally for example), then the photo elements in pixels 31 and 32 are electrically connected as are the photo elements in pixels 32 and 33. Similarly, if pixels 31, 40 and 49 are binned (vertically for example), then the photo elements in pixels 31 and 40 are electrically connected and so are the photo elements in pixels 40 and 49. If binning between pixels in the “super” pixel is not allowed due to unacceptable spatial gradient value, photo elements between pixels that make up the “super” pixel may be electrically disconnected.

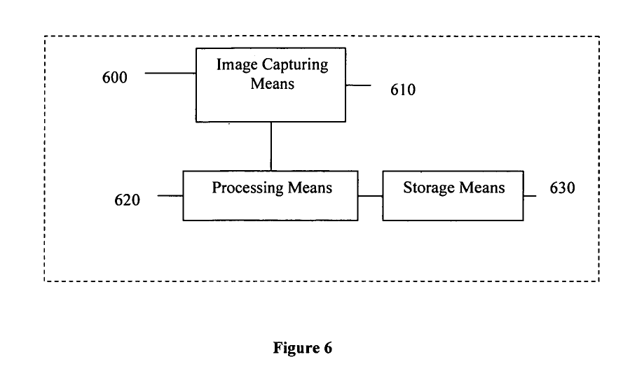

A device for facilitating methods described above may be illustrated in FIG. 6. Device 600 may include a processing means 610, an image capturing means 620 and a storage means 630. Processing means 610 may be connected to the image capturing means 620 and to the storage means 630. Device 600 may be a digital camera, a camcorder or a camera-phone imager for example. Image capturing means 620 may be an image sensor such as a CCD or a CMOS image sensor. Processing means 610 may be a programmable digital signal processor (DSP) or an Application Specific Integrated Chip (ASIC).

Processing means 610 may instruct the image capturing means 620 to capture the contents of a scene for example. The captured contents may be received by the processing means and stored in the storage means 630.

Processing means 610 may then analyze the image (representing the contents of the scene) by measuring the brightness values and computing the spatial gradient values. The lookup table for determining pixel size may be stored within the storage means 630. Processing means 610 may also determine a pixel size for each pixel based on the measured brightness and computed spatial gradient values.

A binning pattern may be determined and communicated to the image capturing means. The image capturing means may then capture contents of the scene in a second pass based on the binning pattern.

It is expected that this invention can be implemented in a wide variety of environments. The device need not be limited to a digital camera, a camcorder, etc. In alternative embodiments, the processor may be remote from the image sensor. However, such arrangement may present challenges to rapidly evaluating contents of a scene and establishing a binning pattern before capturing contents of the scene in a second pass. Delay between the first and second passes may lead to changes in the composition of the scene for example. If the scene remains static between first and second passes, the remote location of the processing means with respect to the image sensor may be acceptable. The device may also include a scanner.

It will also be appreciated that procedures described above are carried out repetitively as necessary. To facilitate understanding, aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

It is emphasized that the terms “comprises” and “comprising”, when used in this application, specify the presence of stated features, integers, steps, or components and do not preclude the presence or addition of one or more other features, integers, steps, components, or groups thereof.

Thus, this invention may be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

1. An image processing method comprising:
capturing contents of a scene in a first pass;
determining a binning pattern for pixels representing said scene based on measured brightness values of the pixels; and
capturing contents of the scene in a second pass in accordance with the binning pattern.

2. The method of claim 1, wherein binning of pixels occurs between neighboring pixels.

3. The method of claim 2, wherein a decision to bin pixels is based on evaluating a difference in brightness values between the pixels being considered for binning.

4. The method of claim 3, wherein a threshold of the brightness difference values for permitting binning is specified in a lookup table.

5. The method of claim 4, wherein the threshold value is associated with a particular measured brightness value.

6. The method of claim 5, wherein a measured brightness value of one of the pixels being considered for binning is used to refer to the lookup table.

7. The method of claim 5, wherein an average measured brightness value of the pixels being considered for binning is used to refer to the lookup table.

8. The method of claim 1, wherein the image is captured by an image sensor utilizing a Bayer Mosaic pattern.

9. The method of claim 1, wherein the binning pattern occupies a pixel space having an arbitrary shape.

10. The method of claim 1, wherein the binning pattern includes binning of pixels having a same color in the Bayer pattern.

11. The method of claim 1, wherein the first pass is captured at a resolution that is lower than a resolution corresponding to the capture during the second pass.

12. The method of claim 11, wherein the image is binned uniformly during the first pass capture.

13. An image processing method comprising:
capturing contents of a scene in a first pass at a first resolution;
measuring brightness values of pixels representing said scene;
evaluating a spatial gradient of the pixels;
determining a binning pattern for the pixels based on the spatial gradient; and
capturing contents of the scene in a second pass at a second resolution in accordance with the binning pattern wherein the second resolution is higher than the first resolution.

14. The method of claim 13, wherein binning takes place between neighboring pixels.

15. The method of claim 14, wherein binning is permissible if the spatial gradient of a pixel is below a predetermined threshold.

16. The method of claim 15, wherein a plurality of spatial gradient threshold values and associated brightness values are stored in a lookup table.

17. The method of claim 16, wherein the lookup table includes horizontal and vertical threshold values for the spatial gradient.

18. A computer-readable medium containing a computer program for processing an image, the computer program, executing on a processor, causes the processor to:
instruct an image sensor to capture contents of a scene in a first pass;
determine a binning pattern for pixels representing the scene based on measuring brightness of pixels representing the scene; and
instruct the image sensor to capture contents of the scene in a second pass in accordance with the binning pattern.

19. A device, comprising:
an image capturing means for capturing contents of a scene;
a processing means for:
instructing the image capturing means to capture contents of the scene in a first pass;
evaluating pixels representing the scene to determine a binning pattern; and
instructing the image capturing means to capture contents of the scene in a second pass according to the binning pattern, and
a storage means.

20. The device of claim 19, wherein the storage means includes a lookup table.

21. The device of claim 20, wherein the lookup table includes brightness values and corresponding threshold values for brightness difference, said threshold values being utilized for binning of pixels.

22. The device of claim 19, wherein the image capturing means is an image sensor.

23. The device of claim 19, wherein the device is a digital camera or camcorder.
